(19) United States
(12) Patent Application Publication
(10) Pub. No.: US 2006/0072869 A1
(43) Pub. Date: Apr. 6, 2006

(54) Optical fiber position transducer for flow control valve in smart wells

(75) Inventors: Jose Luiz Arias Vidal, Tijuca (BR); Manoel Feliciano Da Silva Junior, Tijuca (BR); Ricardo Munoz Freitas, Tijuca (BR); Arthur Martins Barbosa Braga, Leblon (BR); Luiz Carlos Guedes Valente, Copacabana (BR); Roberth Waldo Angulo Llerena, Copacabana (BR)

Correspondence Address: NIXON & VANDERHYE, PC, 901 NORTH GLEBE ROAD, 11TH FLOOR, ARLINGTON, VA, 22203, US

(73) Assignee: Petroleo Brasileiro S.A., Petrobras (BR)

(21) Appl. No.: 11/235,529

(22) Filed: Sep. 27, 2005

(30) Foreign Application Priority Data
Sep. 29, 2004 (BR) PI 0404127-5

(51) Int. Cl. G02B 6/00

(52) U.S. Cl. 385/13; 385/37

(57) ABSTRACT

A fiber optics position transducer is described (100) for flow control valve in smart wells, which comprises at least two load cells (10) instrumented with Bragg (FGB) network sensors and supported by rings (20a, 20b). The cell (10) is formed by a quadrangular body (11), provided with a central hole (12) and hole (13a/13b) for inlet/outlet and passage of a fiber optic (14) and pins (14a, 14b). Said cell (10) measures the displacement of a spring used in the sliding sleeve, rotating or choke type valve from the smart completion system, the displacement (opening or closing) of the valve being monitored from the restoration force in the spring measured by the instrumented load cell (10). The transducer (100) is built with dimensions and geometry so as not to present edges and allow the insertion of the same in the annular space of a sliding sleeve, rotating or choke type valve of an oil production system. In addition, the transducer's (100) construction is such that allows it to be multiplexed to other kinds of well sensors, through the same optical fiber.

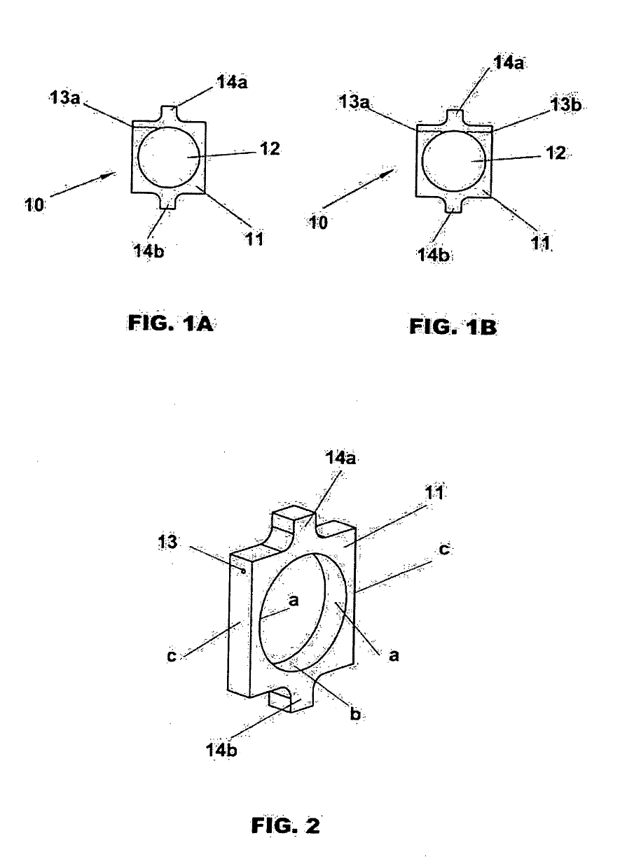

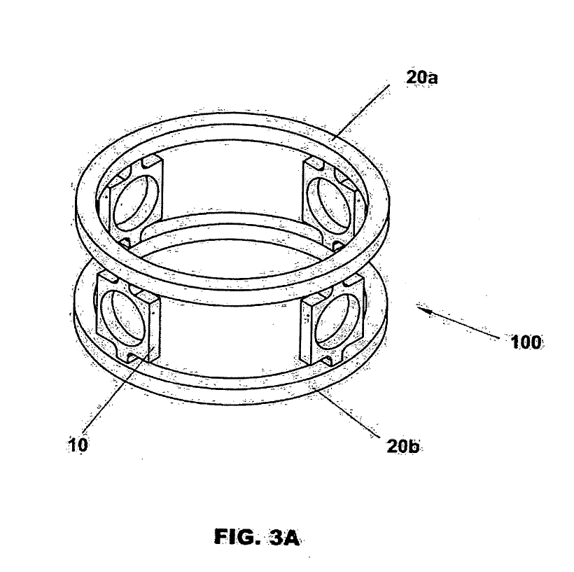

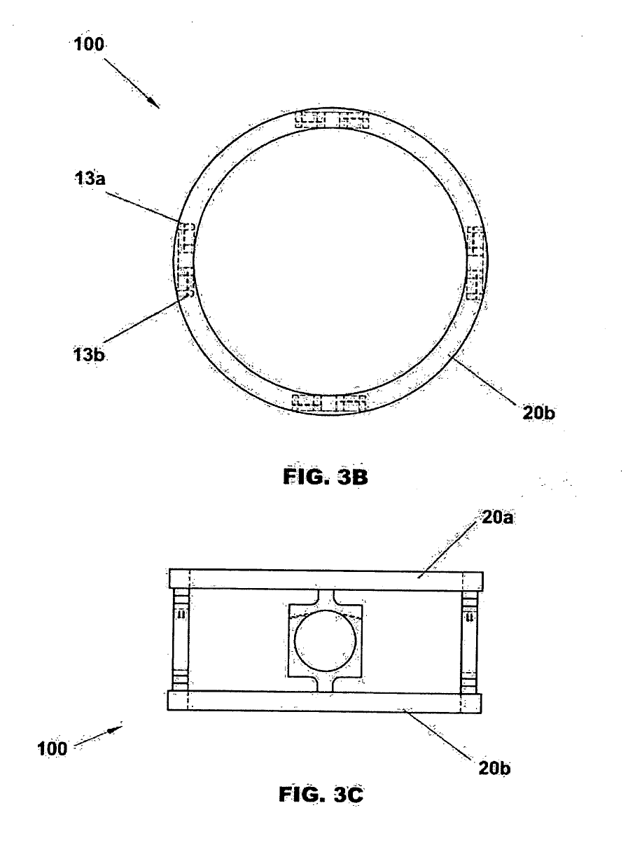

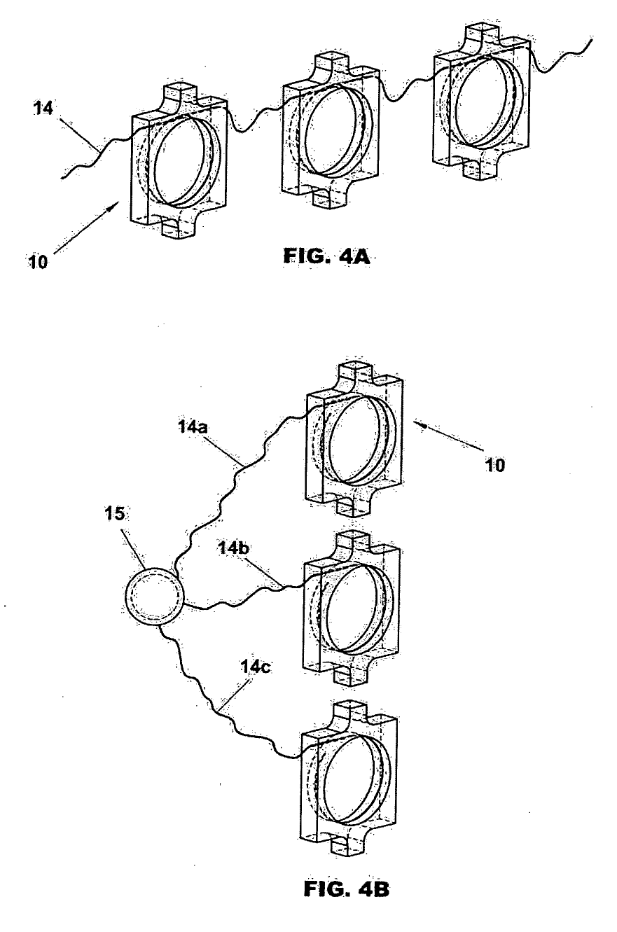

### INVENTION FIELD

This invention belongs to the field of optical fiber transducers for monitoring in real time the well parameters, more specifically, transducers to monitor the to monitor the opening or closing percentual of the production or injection flow control valves in smart wells.

### INVENTION GROUNDS

As from the performance of research activities for optical fiber applications in the telecommunication sector, it is being developed parallel efforts in order to develop sensoring techniques using optical fiber for measuring the most distinct physical, chemical and even biological quantities. Such interest is motivated by some characteristics inherent to the optical fiber, such as low weight, flexibility, long distance transmission, material's low reactivity, electric isolation and electromagnetic immunity. Another attracting factor of the optical fiber sensoring is that the signals' multiplexion from several sensors along the fiber can be easily accomplished, and they can be inclusively measuring different amounts. Another possibility is to perform the continuous measurement along the fiber.

The oil and gas sector (SPG) presents several application opportunities for the optical fiber sensors (SFO). The abovementioned characteristics may be determining in several situations, either in the segments of exploration, transport, refinery or distribution. In many case, conventional technologies are unable to attend the expectancies for more accurate, continuous measurements in a larger number of points, under high temperatures and in the aggressive envioronments found in applications within the several segments of the production and distribution chain of oil and its by-products. At the same time, as to the application costs, the optical fiber sensors, which uses optical and electronic components regularly used in the telecommunication sector and benefits from the production scale of the huge photonics sector, are becoming more competitive each day, especially in systems that include a large number of measuring points.

The main international operators of the oil and gas (SPG) sectors, among which the Applicant is, identified the Optical Fiber Sensors' technology (SFO) as the key element to make the set-up of the smart completion systems of oil wells (either production or injection) available, with all the expected functionality available. The well sensoring allows the acknowlegment, anytime, of accurate information about several quantities, among which pressure, temperature, flow, pH or even about the positioning of the valves that control the flow through the well. The real time monitoring of the well is part of the automation strategy of all the oil wells' production process.

Among the several application areas of the optical fiber sensors, this scenery made SPG be the stage of more intense and bigger movement in recent years. However, few products are commercially available and there is a lack of safe information about their performance.

The technology of Bragg's Network in FBG (Fiber Bragg Grating) presents advantages in comparison with other fiber-made alternatives.

The smart completion may be defined as a system able to collect, transmit and analyse data allowing the remote drive of flow control devices in order to always accomplish the reservoir production in the best flow local. A typical smart well has monitoring and performance devices set up in their different production or injection zones. In this kind of implementation, the intention is to increase the well's contact area with the producing formation, combining the production of the different zones in the best way.

One of the main elements of the well is the sensoring system. In order to advance in the smart completion technology, increasing the number of wells where this concept might be explored, the reliability of the sensoring systems is the key word. The electronic sensors for the permanent monitoring of the bottom of wells are already known for many years now in the upstream segment of the oil and gas sector. However, their limitations and their high failure rates, mainly while operating in moderate high temperatures, motivated operators and service companies of the sector to seacg alternatives in the technology of optical fiber sensors.

Along the second half of the 90's, the huge potential of a new component of the demultiplexing systems for telecommunications through optical fibers, Bragg's network, began to be explored for sensoring the quantities of the well's' bottom.

In the article “Intelligent Well System—Where we've been and where we're going”, World Oil Magazine, March 2003, Vol. 224 No. 3, J. Angel mentions that the evolution of three technologies of the oil industry (measurement at the well's bottom, sliding sleeve valves and the control of safety valves at the surface) allowed the development of smart wells. The first implementation of the smart completion appeared at the end of the 80's, with the set up of pressure-temperature measurers to provide real time readings of the condition of the bottom of wells. The real time flow control without interventions did not appear until the end of the 90's. Before this, the flow within a zone could only be modified through an intervention in the rig or through a squeeze or through the movimentation of a sleeve valve.

Currently, the smart well systems are managed through communication networks that provide real time monitoring in the production or injection wells, rate/model data and an action under the form of remote control of flow. The smart well systems acquire parameter data of sensors allocated in the well and allow the operator to change the flow characteristics (production or injection) without the need to make a well's intervention. The measurements are made in the zones of interest. Thus, permanent sensors in the well contribute to improve the attendance of production and/or injection specific zones, as well as the characteristics of the reservoir around the well.

The smart wells' technology comprises two instantaneous primary concepts: the first one, the real time supervision, which refers to the ability to acquire flow data in the bottom of wells or reservoir, and the second one, the real time control, that is the capacity to remotely conrol the flow by starting any shut-off device or valve.

L. A. Giangiacomo and D. R. Hill, in the article “Optimizing Pumping Well Efficiency with Smart Fluid-Level Controller Technology” SPE 52210, SPE International, 1999, refer to a fluid level controller, allowing the automatization of an electric pump with flow level data in real time. Besides, the pressure at the bottom of the well may be monitored and its values may be optimized to improve and make the operation of the different artificial lifting techniques more cost-efficient.

Sigurd M. Erlandsen, in the article “Production Experience from Smart Wells in the Oseberg Field”, SPE 62953, SPE International 2000, reports experiences made with offshore smart wells in Oseberg Fielf, in Norway, at 100 meters deep. The tests were made in four wells with excessive gas production; the objective was to remotely control the gas production. In the first well there was the installation of a smart completion jointly with conventional sliding-sleeve valves. The purpose was to be able to block the zone backwards in the event the gas invaded it. In the second well, four zones were completed with smart completion; it has been produced one zone at a time through the test separator so there was no impurity at the tubing and to establish the productivity index (PI), the oil-gas ratio (RGO) and the water irruption in each zone, independently. The third well was also completed with four zones with smart completion. At the begining of the production, all sensors were operating normally; but just after 40 production days, the communication was lost after the first zone, but even with this event, the production was not interrupted. The fourth well was completed in three zones with smart completion; technically, the operation of the three zones was satisfactory, but the well undergone problems at the beginning of the production because it registered low resistance to pressure and problems with the oil lifting.

M. Thompson and E. D. Parker, in the article “Predicting the Reservoir Response to Intelligent Wells”, SPE 65143, SPE International 2000, modelled a smart well, whose biggest challenge was to develop a model which would correctly inform in advance the flow and pressure distribution in the completion, as well as in the cross-section section of the well in the reservoir for any position of the choke valve so it could soon be applied as a tool for managing the reservoirs. The performance of the model is evaluated in homogeneous and heterogeneous simple environments in order to understand how the completion design and the choke valve's hole influence the distribution of pressure and flow within the well and the reservoir; soon the model is adapted and introduces in two developed reservoirs' sceneries. One of the sceneries is an uniform reservoir with a vertical smart well; the second is a reservoir with the presence of failures and two sided-ramals, which incorporate a valve with variable choking. The performance of the developed fields are compared with well with conventional completion.

G. Cobertt et al, in the article “Fiber Optic Monitoring in Open hole Gravel Pac Completions”, SPE 77682, SPE International 2002, present a work of smart completion in optical fiber. The article describes the development and application of a gravel pack system which incorporate a pipe for the optical fibers holding temperature sensors distributed or discrete along the gravel pack. For the assembly of the system, it was the adjustment of an advance channel to the pipe, consistent with the by-pass tool of the gravel; soon it was also required a method to establish the connection of the production tubing to the gravel pack packer and to establish a continuous conduct for the optical fiber from the surface until the end of the gravel mash. It is presented herein a table with the problems faced during the tests and the implemented solutions are summarized in the said table; another table provides the estimated operational terms to make the system operate.

G. Brown et al, and M. Al-Asimi, in the article “Monitoring Horizontal Producers and Injectors During Cleanup and Prediction using Fiber-Optic Distributed Temperature Measurements”, SPE 84379, SPE International 2003, also present a work about optical fiber in smart completion. The work describe the application of a distributted system of temperature in optical fiber installed at long horizontal intervals of opened completion in production and injection wells in Oman. The temperature monitoring allowed the optimization of the completion methods and the improvement of the reservoirs' knowledgement and their performance. The results show that it is possible to monitor continuously the long intervals opened during the well's production and cleaning, without requiring multiple interventions.

A Bragg's network is a reflexive optical filter with very high spectral selectivity. Its construction is based in the ability to generate a periodical modulation in the refraction rate of the fiber's core; this structure reflects efficiently the lenght of the wave—λ_{b}—that meets the Bragg's condition in the first order for normal incidence, that is:
λhd b=∇/2n
Where ∇ is the spatial period of the index modulation and n the refraction rate of the fiber.

The sensoring capacity of Bragg's network is related to the fact that λ_{b} may be altered by mechanical efforts that modifies the periodicity of the structure, ∇, or through the temperature that modifies the refraction rate n. These associations may be properly summarised, as an approximation, in the expression:
Δ_{b.}/λ_{b}=9×10⁻⁶ΔT+0,78ε
Where ΔT is measured in ° C. and ε is non-dimensional (m/m). The numeric constants are characteristics of the material which compound the fiber and, especially the thermal Constant, may present variations between the fibers. The great attractive for the use of the Bragg's network for sensors lies in the fact that the information is within the spectrum, what means to say that it is na absolute measure that can be easily multiplexed.

The acronym LVDT are the i “Linear Variable Differential Transformer”, an ordinary type of electromechanical or optical transducer that can convert the rectilinear movement of an object to which it is mechanically coupled in a correponding electric signal.

Many technologies may be applied for the positio sensors, and the oldest of them comprised a simple resistive potentiometer. This equipment's disadvantage is that there is a mobilie contact sliding in fixed conductors; this causes noise and allows a quick ageing of the sensor. For a good accuracy and a longer life, of the sensor, it is adviseable there is no mechanical contact with the sensor element. Nowadays, there are four sensors' technologies which complies with this requirement:
Capacitivite;
Optical;
Inductive; and
Optical Fiber
Capacitive: These sensors allow a good accuracy for the measurements, but they have a reduced dynamic range. Another disadvantage is its sensibility to vibrations, humidity and other parameters.
Optical: These sensors allow a good accuracy and provide a large measurement range; in many instances, the signals provided by these sensors are digital ones. These sensors are extensively used in tool machines, but they must be protected from environment, especially from dust. In general, they are high cost and fragile solutions.
Inductive: In some applications they compete with the optcial sensosrs in the measurement and accuracy ranges. Besides, its great advantage in relation to the former ones is its capacity to work under severe conditions without modifying its performance. In truth, they are insensible to non-magnetic particles, humidity and vibrations.
Optical Fiber: The newest development technique is the one based on optical fibers. The optical fiber sensors are easily developed and have a good performance. In truth, it refers not only to one technique, but to several techniques whose common characteristic is the fact they both use optical fiber as a guide of the light used in the measurement.

Among the sensoring techniques that use optical fiber are those based on Bragg's Networks (FBG), that up to the moment, have not been apllied in position sensors. In order to develop an LVDT using FBG as a sensor element, it is determined the state-of-art in what refers to LVDT position transducers in general.

It is known several development techniques for LVDT transducers, and the most common of them is the one that uses electric induction as an operating principle. As it is the prevailing technique, it is presented herein its operating principle and some typical characteristics. It is also presented aome measuring possibilities using optical fibers.

The main advantage of this kind of LVDT transducer over other kid of displacement transducers is its high level of robustness. This derives from its operating principle in which there is no physical contact with the sensor element, and thus, there is no detrition of this element. This means that the LVDT transducers may be made with water-proof carachteristic and in a proper way for the most difficult applications.

Normally, an LVDT transducer of this king has three types of rolls, being one of stimulation (primary) and other two of collection (secondary). The first roll is stimulated with alternate current, normally within the range of 1 kHz through 10 kHz with voltages from 0,5 v to 10 v RMS. The secondaries rolling is such that when a ferrous core is positioned in the central position, the two rolls provide voltages with the same extent, but lacking π. The core is the mobile part of measurement system and it is normally coupled to a non-magnetic rod that touches the point whose displacement one intends to measure. About this subject, refer to an article written by G. Duplain, C. Velleville, S. Bussière and P. A.Bélanger: Absolute fiber-optic Linear Position and Displacement Sensor; 12^{th} International Conference on Optical Fiber Sensors, Williamsburg, Va. 1997; pp 83-86.

Another type of positioning transducer is the one that uses optical fiber. Some manufacturers (Philtec, Fiso) have developed positioning transducers commercially and, also, University and Labs' researchers have examined several models.

Some transducers are based in the lighting intensity while others are based on the interferometry. As it is well known, the bid advantage of the sensors and transducers with optical fiber is the lack of electric signals near the measuring point. This prevents problems of electromagnetic interference, what is critical when it is required long distances, and make the optical fiber sensors completely safe in areas with risk of explosions.

Despite all previously mentioned works about LVDT, inclusively in Optical Fiber, it has not been found any reference based in FBG as a sensor element. Considering the advantages of the sensors based in FBG in comparison with other possibilities comprising optical fibers, it is being searched a way to measure the position that uses this technology and, simultaneously, do not require direct contact between the mobile element of the transducer and the FBG.

On the other hand, it may be found in the market na infinite number of load cells, based on different operation principles. Most of them uses conventional electric resistive sensor elements (electric extensometers). As evidenced, up to the the present time, there are no load cells provided commercially which use optical fiber sensors as a measuring principle.

Epsilonics magazine presents a collection of articles grouped under the title Modern Strain Gauge Transducers: Their Design and Construction. This collection comprises the articles from: October 1981, pp 5-7; March 1982, pp 5-6; July 1982, pp 6-8; December 1982, pp 5-7; April 1983, pp 5-7; August 1983, pp 6-7; December 1983, pp 7-9; April 1984, pp 5-7; October 1984, pp 6-11.

In this collection a detailed study about the design and construction of transducers, emphasizing the load cells, is presented. This study describes several designs of load cells to be used with conventional electrical strain gauges (resistive), as well as materials for its construction and the forms of instrumentation for the same. The basic form of load cells for many different uses are presented: tension, compression and shearing, under static or dynamic loads.

Other authors such as: Bray A.; “The Role Of Stress Analysis In The Design Of Force-Standard Transducers,” Experimental Mechanics, January 1981, pp 1-20 e Guindy S. S., “Force And Torque Measurement, A Technology Overview: Part I—Force,” Experimental Techniques, June 1985, pp 28-33 e Guindy S. S., “Force And Torque Measurement, A Technology Overview: Part Ii—Torque,” Experimental Techniques, July 1985, pp 9-15 among others, have published articles and books dealing extensively with load cells.

Therefore, despite the existing developments, the technique still needs a position transducer based on the use of a load cell, instrumented with sensors to Bragg's network, with such cell measuring the dislocation of a spring used in the valve of the sliding sleeve type of the smart completion system, with the valve being activated by a hydraulic or mechanic system. This valve rests over a spring, always working under compression, which guarantees the return to its balanced position after the pressure of the activating system stops. The dislocation (opening or closing) of the valve is monitored from the restoration force in the spring that is measures by the load cell instrumented with optical fiber sensors. This position transducer is described and claimed in this application herein.

### INVENTION SUMARY

In a broad sense, this invention is about an optical fiber position transducer for the control valve in smart wells, the transducer comprising at least two load cells instrumented with sensors to Bragg's network, to measure the dislocation of the spring used in the valve of the sliding sleeve, rotational or choke type of the smart completion system.

And the functioning of the position transducer described involves the provision of a load cell instrumented with Bragg's networks in the middle of the vertical and horizontal internal surfaces of such cell, activating in a hydraulic or electric manner the sliding sleeve, rotational or choke type valve of the completion system of an injection or production well and the spring over which such valve rests, and monitoring the dislocation (opening or closing) of the valve from the restoration force in the spring to be measured by said instrumented load cell.

Therefore, the invention provides an optical fiber transducer for the flow control valve in smart Wells, with the transducer comprising a load cell instrumented with sensors to Bragg's network.

The invention provides further an optical fiber position transducer for the flow control valve in smart wells, with the transducer being able to quantify a given dislocation as a function of the deformation that is produced in the optical load cell.

The invention also provides the use of a load cell instrumented with sensors to Bragg's network to measure the dislocation of the spring used in the sliding sleeve, rotational or choke type valve of the smart completion system.

The invention likewise provides an optical fiber position transducer for the flow control in smart wells that allows for the real time monitoring of the percentage of opening or closing of the flow control valves for injection and production in smart wells.

The invention provides still an optical fiber position transducer for the flow control valve in smart wells where the real time monitoring of the percentage of opening or closing of the flow control valves is done from the reaction force in the spring measured by the load cell instrumented with optical fiber sensors.

The invention also provides an optical fiber position transducer for the flow control valve in smart wells that can be multiplexed to other sensors measuring pressure, temperature, flow, position pH, etc. at specific points and through the same optical fiber.

### BRIEF DESCRIPTION OF THE DRAWINGS

The attached ILLUSTRATION 1 is a schematic view of a load cell for the invention transducer.

The attached ILLUSTRATION 2 is a schematic diagram of the fixation regions of the Bragg's networks in the load cell.

The attached ILLUSTRATION 3 is a view in perspective of the invention transducer with the load cells.

The attached ILLUSTRATION 3B is a view from above of the transducer.

The attached ILLUSTRATION 3C is a frontal view of the transducer.

The attached ILLUSTRATION 4A is a schematic diagram of a modality of interconnection of the Bragg's networks in the load cell.

The attached ILLUSTRATION 4A is a schematic diagram of another modality of interconnection of the Bragg's networks in the load cell.

### DETAILED DESCRIPTION OF THE PREFERRED MODALITY

Under a certain aspect, the invention deals with an optical fiber position transducer for the flow control valve in smart wells, with the transducer comprising at least two load cells instrumented with sensors to Bragg's network to measure the dislocation of the spring used in the sliding sleeve, rotational or choke type valve of the smart completion system.

The transducer is capable of quantifying a given dislocation as a function of the deformation produced in the optical load cell so as to allow the real time monitoring the opening or closing percentage of the flow control valves for production and injection in smart wells.

The position transducer can be multiplexed to other sensors measuring pressure, temperature, flow, position pH, etc. at specific points and through the same optical fiber.

According to the invention concept, the load cell instrumented with sensors to Bragg's network measures the dislocation of the spring used in the sliding sleeve, rotational or choke type valve of the smart completion system. The valve is activated by a hydraulic or electric system and rests on a spring, which is always working under compression, and this guarantees its return to its balance position after the action of the hydraulic system stops. The dislocation, in terms of opening or closing of the valve, will be monitored from the restoration force in the spring measured by the instrumented load cell.

In a general sense the load cell to be instrumented with the optical fiber containing Bragg's network is square in its shape, with a central hole. The transducer is formed by a single milled part, with the load cells and support rings of the same. The optical fiber containing two Bragg's networks is attached to the load cell at places that are subject to deformations caused by opposed signals, corresponding to tension and compression. The Bragg's networks are attached to the internal walls of the load cells at the same distance from 90°.

The position transducer uses at least two and up to four or more load cells (sensors) by optical fiber comprising equidistant Bragg's networks. The maximum number of load cells depends on the annular space available in the transducer. In a modality, the Bragg's networks are attached in only one cell load, in the middle of the vertical internal surface and in the middle of the horizontal internal surface of the same. After the attachment, by whatever device, of the networks at the chosen positions, the optical fiber containing Bragg's networks is connected to an optical connector.

Alternatively, the optical fiber comprising the Bragg's networks is inserted into two or three load cells in series or parallel, as shown in continuation by Illustrations 4A and 4B.

As to the functioning of the transducer, as it has already been mentioned above, the instrumented load cell measures the dislocation of the spring used in the sliding sleeve, rotational or choke type valve of the smart completion system. The activator of the valve undergoes the action of two forces in opposed directions: one that is exerted by the hydraulic system (or electric) and another due to the spring's reaction. It is implied that the movement (opening or closing) of the activator of the valve is caused on purpose by the variation of the hydraulic pressure exercised over it, generating an imbalance of the forces. Consequently, the valve will move. The compression or distension of the spring will cause a proportionate variation of the reaction force intensity over the optical load cell (position sensor), being used as a basis for the calculation of the activator's position.

Under another aspect, the invention deals with an position transducer by optical fiber for the flow control valve in smart wells adapted to be installed next to the flow control valve and comprised by an load cell instrumented with Bragg's networks and at least one and up to three more load cells, which may either be instrumented or not. Wherever four cells are used, the same shall be positioned at angles of 90° one from the others.

The invention shall be described in continuation in respect to the attached Illustrations.

Illustration 1A shows a schematic view of the load cell (10) used in the invention transducer, which is usually designated by the number (100). The cell (10) is formed by a quadrangular body (11) with a round hole (12) in its middle area and a hole (13a) on one of the sides of the body (11) said hole to be destined for the passage of the optical fiber (which is not represented) comprising the Bragg's networks, to be attached at given areas. The hole (13a) is tangential to the surface of the hole (12) in the body (11). The load is transmitted to the body (11) through pins (14a, 14b).

Illustration 1B shows a schematic view of an alternate configuration for the load cell (10) equipped with holes (13a) for the insertion of the optical fiber and for the exit of the optical fiber (13b), said exit hole to be positioned at an odd angle in respect to the central area of the load cell (10).

Illustration 2 shows the positions of the sensors to Bragg's network in the body (11) of the load cell (10), these sensors meant to measure deformation. As shown by Illustration 2, the Bragg's networks may be attached at the positions “a” (internal, either to the right or to the left of the central area of the hole (13b)), “c” (external, to the right and to the left in the vertical portion of the body (11) and “b” in the area of a pin (14a/14b)). It is impossible to attach a Bragg's network at the other “b” position due to the presence of the hole that is meant for the passage of the optical fiber (which is not represented).

One possible configuration is to attach a Bragg's network at the “c” external position and another Bragg's network at the “a” internal position of the body (11) of the cell (10).

When the transducer is loaded under compression, the wave length of the network attached at “s” shall increase, and then the wave length of the second sensor shall move in a direction that is opposite to the first one when the position transducer is loaded compressively by the spring. The difference between the two wave lengths (Δλ) shall be the parameter of interest in the ratios of deformation and dislocation.

Illustration 3A shows a perspective view of the position transducer (100) with the load cell (10). The transducer (100) is formed by a single milled part with at least two load cells (10) that are supported by rings (20a, 20b). The dimensions of the transducer (100) are such that the same allow for the insertion of the same within the annular space of a sliding sleeve type valve in an oil producing system.

Illustration 3B shows that the transducer (100) is constructed in such a manner not to present any protruding borders. This is due to the necessity of insertion of the transducer into the annular space of a sliding sleeve type valve.

Illustration 3C is a frontal view of the transducer (100), with the load cell (10) and the rings (20a, 20b).

Illustration 4a shows in a schematic form a modality of interconnection of the Bragg's network in load cells (10) connected in series. In this modality the body (11) of the cell (10) has more than one hole (13b) through which the optical fiber comprising the Bragg's network that has been inserted through the hole (13a) is attached in the internal position “a” and in the internal position “b” of said cell and may leave the body (11) of the cell (10) through the hole (13b), and proceed on its route towards the body (11) of another load cell (10), where it enters through a hole (13a) and goes out through an opposite hole (13b), entering into a third body (11) of a load cell (10) through a hole (13a) and exiting through another hole (13b) to connect to another sensor of the same technology of a different technology.

Alternatively the optical fiber comprising the Bragg's network that has entered through the hole (13a) may exit the body (11) of the load cell (10), be attached at the external “c” position and proceed on its route towards the body (11) of another load cell (10), etc.

Illustration 4B shows in a schematic form another modality for the interconnection of the Bragg's network in the load cells (10) connected in parallel. In this modality an optical fiber (14a) comprising the Bragg's networks and connected to a coupler (15) enters through the hole (13) of the body (11) of the load cell (10), is attached at the “a” internal position and “b” internal position of said cell. In an analogous manner, other two optical fibers (14b, 14c) comprising the Bragg's network and connected to the same coupler (15) are attached at the same respective positions of the body (11) of the load cells (10).

There is still another variant comprised within the scope of the invention where one may attach one more Bragg's network from the same optical fiber in the “a” frontal position to the “a” position where a Bragg's network is already attached.

1. Optic fiber position transducer for flow control valve in smart wells, characterized why it comprises a single machined cell, including:
a) at least two load cells (10) where at least one of Said cells (10) is rigged with an optical fiber containing Bragg networks;
b) support rings (20a,20b) of said load cells (10), and where:
the Bragg network instrumentation is intended to measure the displacement, in terms of opening or closing the valve, the spring used in the sliding sleeve, rotating or choke type of valve in the smart completion system in regard to the deformation produced in the cell (10) so as to monitor in real time the percentage of opening and closing of the production and injection flow control valves in smart wells.

2. Position transducer in accordance with claim 1, characterized that said displacement in monitored from the restoration force in the spring measured by the instrumented load cell (10).

3. Position transducer in accordance with claim 1, characterized that it comprises three load cells (10) where at least one is instrumented with Bragg networks.

4. Position transducer in accordance with claim 1, characterized that it comprises four load cells (10) where at least one is instrumented with Bragg networks.

5. Position transducer in accordance with claim 1, characterized that the number of load cells (10) is the maximum allowed by the annular space.

6. Position transducer in accordance with claim 1, characterized that the load cell (10) is composed of a quadrangular body (11) with a circular hole (12) in the central region and a hole (13a) in one of the sides of the body (11), said hole being intended for the entry and passage of the optical fiber (14) containing the Bragg networks.

7. Position transducer in accordance with claim 1, characterized that alternatively the load cell (10) is also provided with an exit hole (13b) for the optical fiber (14).

8. Position transducer in accordance with claim 7, characterized that the hole (13a/13b) is tangent to surface of the hole (12) from the body (11).

9. Position transducer in accordance with claim 7, characterized that the hole (13b) is offset in relation to the hole (13a).

10. Position transducer in accordance with claim 1, characterized that pins (14a, 14b) are intended to transmit load to the body (11).

11. Position transducer in accordance with claim 1, characterized that the optical fiber (14) containing the Bragg networks is inserted in two or three load cells (10) placed in series.

12. Position transducer in accordance with claim 11, characterized that the optical fiber containing the Bragg networks that entered by hole (13a) is attached in position “a” and in position “b” and exits the body (11) of the cell (10) through the hole (13b), and continues the route in direction to the body (11) of another load cell (10), where it enters through a hole (13b) and exits by an opposite hole (13a), entering into a third body (11) of a cell (10) via a hole (13a) and exiting by a hole (13b) to be connected to another sensor of the same technology or of a different technology.

13. Position transducer in accordance with claim 11, characterized that alternatively the optical fiber containing Bragg networks that entered through hole (13a) leaves the body (11) of the cell (10) through the hole (13b), is attached in the external position “c” and continues the route in the direction of the body (11) of another load cell (10), where it enters through a hole (13b) and exits by an opposite hole (13a), entering into a third body (11) of a cell (10) via a hole (13a) and exiting by a hole (13b) to be connected to another sensor of the same technology or of a different technology.

14. Position transducer in accordance with claim 1, characterized that the optical fiber (14) containing Bragg networks is inserted in two or three load cells (10) placed in parallel.

15. Position transducer in accordance with claim 14, characterized that an optical fiber (14a) containing Bragg networks is attached to a coupler (15) enters by the hole (13) of the body (11) of the cell (10), is attached in the internal position “a” and in the internal position “b” of said cell, and in an analogous manner, two other optical fibers (14b,14c) containing Bragg networks and connected to the same coupler (15) are attached in the same respective positions of the body (11) of said load cells (10).

16. Position transducer in accordance with claim 15, characterized that alternatively more than one Bragg network of the same optical fiber (14) is attached in position “a” frontal the position “a” where a Bragg network is already attached.

17. Position transducer in accordance with claim 1, characterized that the Bragg networks are attached in positions “a” (internal, to the right and left in the vertical part of the body (11)) and “b”, in the region of a pin (14b).

18. Position transducer in accordance with claim 1, characterized that alternatively a Bragg network is attached in the external position “c” and another Bragg network in internal position “a” of the body (11) of the cell (10).

19. Position transducer in accordance with claim 1, characterized that the optical fiber (14) containing two Bragg networks is attached in locations of the load cell (10) subject to the deformations of opposites signs, corresponding to traction and compression.

20. Position transducer in accordance with claim 1, characterized that it is built with dimensions and geometry so as not to present edges and allow the insertion of the same in the annular space of a sliding sleeve, rotating or choke type valve of an oil production system.

21. Position transducer in accordance with claim 1, characterized that it allows real-time monitoring of the percentage of opening and closing of the production and injection flow control valves in smart wells from the force of reaction in the spring measured by the load cell (10) instrumented with fiber optics sensors to Bragg networks (FBG).

22. Position transducer in accordance with claim 1, characterized that it can be multiplexed to other sensors for other physical parameters in specific points and through the same optical fiber.
